(19) United States
(12) Patent Application Publication
(10) Pub. No.: US 2022/0118523 A1
(43) Pub. Date: Apr. 21, 2022

(54) OPTICAL HEAD FOR POWDER SPRAY 3D PRINTING

(71) Applicant: AddUp, Cebazat (FR)

(72) Inventors: JEAN-LUC SEBAL, PARIS (FR); GUILLAUME CADOUX, PARIS (FR)

(21) Appl. No.: 17/419,110

(22) PCT Filed: Dec. 27, 2019
(86) PCT No.: PCT/EP2019/087112

§ 371 Date: Jun. 28, 2021

(30) Foreign Application Priority Data
Dec. 28, 2018 (FR) 1874350

(51) Int. Cl. B22F 12/53; B33Y 30/00; B33Y 40/00; B22F 10/73; B22F 12/70; B23K 26/14

(52) U.S. Cl. CPC B22F 12/53; B33Y 30/00; B23K 26/1476; B22F 10/73; B22F 12/70; B33Y 40/00

(57) ABSTRACT

A powder dispensing head (1) for an additive manufacturing machine comprises a through-opening designed to allow the passage of a high-energy beam towards the melting point, a body (2) comprising N powder conveying ducts uniformly distributed about the through-opening and converging towards the melting point, a dispensing member (3) comprising a powder dispensing chamber having a powder inlet, and N powder outlets uniformly distributed about the through-opening, the body (2) and the dispensing member (3) being configured to be able to move relative to one another so as to fluidically connect or disconnect the powder outlets with respect to the respective powder conveying ducts according to the relative position of the dispensing member (3) with respect to the body (2).

### TECHNICAL FIELD

The invention relates to the field of manufacture using 3D printing, employed in numerous technical fields such as the automotivgeee or the aeronautical field.

More particularly, the invention relates to a head of a powder-jetting 3D printer and to a printer comprising such a head.

### PRIOR ART

Additive manufacturing or 3D printing denotes a collection of methods that enable an object to be manufactured by the superposition of layers of materials, for example metallic or plastic materials, on the basis of a digital model.

This manufacturing process allows the creation of more complex shapes than can be created using the conventional machining techniques that involve the removal of material.

Powder jetting additive manufacture is one of the most promising additive manufacturing techniques. This technique consists in melting one or more powder(s) using a high-energy beam, for example a laser beam, so as to lay down a deposit of well-controlled dimensions. The layers of material are successively stacked to create functional technical parts.

Furthermore, this technology allows savings of material compared with conventional machining, in which the removal of material can, for example, amount to as much as 80% of the finished part.

A powder jetting 3D printer has a printing head connected to at least one source of powder via a powder dispenser which dispenses the powder to a powder conveying duct. The powder is conveyed in a stream of carrier gas, for example argon, and is carried to a melting point to be melted by a beam, for example a laser beam.

In known 3D printers of the prior art, the siting of the dispenser is distant from the printing head, generally outside the machine chamber, for space and maintenance reasons.

This means that the conveying duct is of a substantial length, which leads to a lengthy response time between start-up and the arrival of powder. This response time is detrimental since it makes it impossible to stop the flow of powder between two movements of the printing head without a laser shot. This can therefore cause a significant loss of powder during the manufacture of a component.

The objective of the invention is to provide a solution to the above-mentioned problem by proposing a powder dispensing head that is able to limit powder losses and a 3D manufacturing machine comprising such a dispensing means.

### DESCRIPTION OF THE INVENTION

To this end, one subject of the invention is a powder dispensing head, also known as a printing head, for an additive manufacturing machine, said head comprising:

a body comprising at least one powder conveying duct leading to a melting point, which may be situated substantially on a substrate on which the manufacturing is being performed,

a through-opening designed to allow the passage of a high-energy beam towards the melting point, in order to interact with the powder.

The high-energy beam is, for example, a laser beam.

According to the invention, said dispensing head further comprises a dispensing member comprising at least a first powder dispensing chamber having a first powder inlet, and at least one first powder outlet, the body and the dispensing member being configured to be able to move relative to one another so as to fluidically connect or disconnect the first powder outlet with respect to the powder conveying duct according to the relative position of said dispensing member with respect to the body. This relative movement may, for example, be a translational or rotational movement of the one with respect to the other.

Thus, unlike in known printers in which the dispensing member is distant from the printing head, according to the invention, a powder dispensing member is comprised within the 3D printing head. This then considerably reduces the length of the powder conveying duct which carries the powder to the melting point.

Furthermore, thanks to the relative movement between the body of the head and the dispensing member, the supply of powder can be cut off quickly when the laser is cut off. This results in a considerable saving of powder.

According to one embodiment, the dispensing member may comprise:

a first powder dispensing chamber having a first powder inlet and at least one first powder outlet, and

a second powder dispensing chamber having a second powder inlet and at least one second powder outlet.

The body and the dispensing member have at least one position in which the first powder outlet or the second powder outlet is fluidically connected to the powder conveying duct.

It is thus possible to switch from a first powder to a second of a different kind in order to manufacture multi-material components.

Advantageously, the dispensing member comprises a mixing means configured to send into the powder conveying duct a mixture made up of a proportion of the first powder leaving the first chamber and a proportion of the second powder leaving the second chamber.

This allows the manufacture of objects made up of a mixture of powders. Furthermore, proportional metering of two powders PA and PB allows the manufacture of components the characteristics of which are changeable by changing the PA and PB concentrations during manufacture.

Advantageously, the body further comprises a powder recycling circuit configured to remove powder to a recycling container, the dispensing member being configured to fluidically connect the first powder outlet or the second powder outlet to the recycling circuit when this outlet is disconnected from the conveying duct.

This means that the powders can be recycled and a constant flow of carrier gas can be maintained, preventing powder residue from settling in the ducts.

According to one embodiment, the body comprises two recycling circuits each one configured to remove a powder to a respective recycling container, the first outlet and the second outlet each being configured to be connected to its respective recycling circuit when it is disconnected from the powder conveying duct.

Thus, two powders can be recycled.

Advantageously, the dispensing member further comprises a purge gas dispensing chamber for a purge gas, preferably a pure gas such as argon, having a gas inlet and at least one gas outlet, the body and the dispensing member having at least one position in which the gas outlet is fluidically connected to the powder conveying duct, to the first recycling circuit, or to the second recycling circuit.

The purge gas allows the various circuits, particularly the first and second chambers, to be purged of powder residue.

According to one embodiment, the body may comprise an external powder conveying duct designed to communicate fluidically with a powder outlet and configured to carry the first powder or the second powder towards the melting point.

This allows a powder to be injected without passing via the main conveying duct internal to the printing head. Specifically, an additive manufacturing head is exposed to the heat associated with the laser beam and to the radiation given off the component in the process of being manufactured. Thus, when the first powder requires a high heat input while the second powder does not, then the first powder is injected via the main conveying duct and the second via the external duct. This then allows the second powder to be included in the molten pool without it being needlessly heated.

Advantageously, the powder dispensing head further comprises a cooling circuit configured to circulate a cooling fluid, for example a liquid between an inlet and an outlet for said fluid.

Cooling using a liquid guarantees good cooling of the head. The heat may be disseminated to the body of the head, the tip of the head being very fine and fragile, the heating thereof accelerates the effect of the adhesion of slag and therefore the deterioration of the focused stream of powder.

The water circulation network in the head constitutes a heat shield for the internal mechanical components and seals, and in particular the body is able to benefit from a very high surface area for exchange with the cooling system.

According to one embodiment of the invention, the body has a conical shape, the through-opening being arranged between the base and the vertex of the cone.

According to another embodiment of the invention, the dispensing member has the shape of a ring designed to collaborate with the base of the cone and is able to rotate with respect thereto.

Advantageously, the through-opening passes along the axis of the cone. In that case, the rotation of the ring with respect to the base of the cone may be about the axis of the cone.

Advantageously, the body comprises a number N of powder conveying ducts uniformly distributed about the through-opening and converging towards the melting point.

N may be greater than or equal to 2.

Advantageously, the first and/or the second recycling circuit has N inlets adjacent to an inlet of a powder conveying duct.

Advantageously, the first and/or the second powder dispensing chamber and/or the gas chamber has N outlets uniformly distributed on the ring.

According to one embodiment which combines certain features described hereinabove, the powder dispensing head for an additive manufacturing machine comprises:

a through-opening designed to allow the passage of a high-energy beam towards the melting point,

a body comprising N powder conveying ducts leading towards a melting point, said ducts being uniformly distributed about the through-opening and converging towards the melting point,

The dispensing head may further comprise a dispensing member comprising at least one powder dispensing chamber having an inlet for powder (the powder being transported by a gas, and N powder outlets uniformly distributed about the through-opening in such a way that each powder outlet can be connected to a respective powder conveying duct, the body and the dispensing member being configured to be able to move relative to one another so as to fluidically connect or disconnect the powder outlets with respect to the powder conveying ducts according to the relative position of said dispensing member with respect to the body, N being greater than or equal to 2.

The plurality of powder conveying ducts and the plurality of powder outlets mean that the powder can be dispensed and conveyed uniformly as far as the melting point and better melted. Specifically, the dispensing chamber allows the powder to be distributed upstream of the conveying ducts via the powder outlets, and then the powder is conveyed by the respective conveying ducts and therefore arrives at the melting point in a manner that is distributed around the laser beam, allowing the melting point to be reached very quickly.

This configuration is advantageous in comparison with the known additive manufacturing heads of the prior art. Specifically, in the known additive manufacturing heads, there is no distribution upstream of the powder conveying duct and the powder arrives via a single path. In that case, the powder has to be distributed in the body via a recess in the form of a ring and then onto a focusing cone, or else concentric nozzles. This distribution requires a sufficient buffer volume and significantly lengthens the response time needed to obtain a uniform flow at the focal point. That system therefore entails observing a “pause” time to ensure a uniform flow of powder, which consequently leads to a loss of powder and a loss of time.

According to one embodiment, the dispensing member may comprise:

a first powder dispensing chamber having a first powder inlet and N first powder outlets uniformly distributed about the through-opening,

a second powder dispensing chamber having a second powder inlet and N second powder outlets,

the body and the dispensing member having at least one position in which the first powder outlets or the second powder outlets are fluidically connected to the respective powder conveying ducts.

According to yet another embodiment, the dispensing member may comprise:

a first powder dispensing chamber having a first powder inlet and N first powder outlets uniformly distributed about the through-opening,

a second powder dispensing chamber having a second powder inlet and N second powder outlets,

the dispensing member further comprising one or more powder mixing means simultaneously connecting a first powder outlet and a second powder outlet to a common powder conveying duct.

Advantageously, each pair made up of a first powder outlet and of a second powder outlet may be connected to a respective powder conveying duct by a mixing means

According to another embodiment:

the body comprises a number N of powder conveying ducts which are uniformly distributed about the through-opening and converge towards the melting point, the first recycling circuit and the second recycling circuit each having N inlets each one adjacent to an inlet of a powder conveying duct,

the first and second powder dispensing chambers and the gas chamber each have

N outlets distributed on the ring so that each of the N outlets faces one of the N inlets of the body, N being greater than or equal to 2.

The multiplicity of the conveying ducts and of the powder outlets means that the powder can be dispensed and conveyed uniformly as far as the melting point. In other words, the powder reaches the melting point in a manner that is distributed around the laser beam, allowing better melting of this powder.

The powder dispensing head may advantageously be manufactured using 3D printing. In that case, the powder dispensing head may comprise an inbuilt cooling network acting at all levels of the body by passing through various external and internal parts of the body.

Unlike in the known systems in which the head is generally provided with a cooling collar, the cooling system according to the invention is a network of cooling ducts which passes through the entire body inside and out. This allows the creation of a heat shield towards the outside and ensures internal cooling of the members.

The invention also relates to a powder jetting additive manufacturing machine comprising a powder dispensing head according to the above description.

The features of the embodiments described hereinabove may be considered separately or together or in various combinations.

### BRIEF DESCRIPTION OF THE FIGURES

The invention will be better understood and further features and advantages will become apparent from reading the description which will follow, the description referring to the attached drawings, among which:

FIG. 1 is a schematic and partial view of a known 3D printing facility according to the prior art;

FIG. 2 is an overall view of a printing head according to the invention;

FIGS. 3 and 4 respectively depict a dispensing member and a main part of a body of the head according to FIG. 2;

FIGS. 5 and 6 are vertical cross sections of the dispensing member of FIG. 3 and of the main body of FIG. 4, respectively;

FIG. 7 is a view in vertical section of the printing head according to FIG. 2;

FIG. 8 is an exploded view of a body of a printing head according to the invention;

FIGS. 9 and 10 are two variants of the head of FIG. 2;

FIG. 11 is a view in section of a printing head equipped with means for mixing two powders;

FIG. 12 and FIG. 13 depict a variant of the head of FIG. 11 allowing a mixture of powders to be created in the cold state.

### DETAILED DESCRIPTION

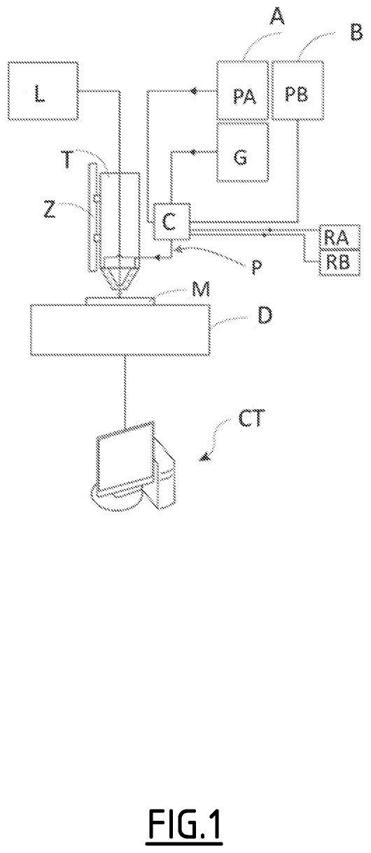

FIG. 1 shows an example of a known powder jetting 3D printing facility of the prior art. The facility comprises a printing head T connected to a first source A of powder PA, and to a second source B of powder PB. To manufacture an object M, a conveying duct P conveys the powders PA, PB as far as a melting point F at which a beam emitted by a laser source L melts these powders separately or in the form of a mixture. With each powder being transported by a carrier gas, a recycling system allows the unused powders PA, PB to be recovered in respective powder recovery containers RA, RB.

In other instances, which have not been illustrated, the facility may be a single-material facility or else may comprise a greater number of powder sources.

The facility also comprises a source of purge gas G, as well as a powder dispensing system, also known as a switchover system C. This system allows the sources A, B of powder PA, PB and the source of gas G to be connected to and disconnected from the conveying duct P or the powder recovery containers RA, RB.

The facility finally comprises a movement system Z for moving the printing head T and a movement system D designed for moving the object M particularly during manufacture in the two directions of the plane X, Y. Finally, a control system CT controls the facility.

The facility may also comprise a device, not illustrated, for metering the powders PA and PB.

The powders may be metallic powders such as: carbon steels and stainless steels, or any metal alloys, for example: nickel bases, cobalt bases, alloys of titanium, of copper or of aluminium, ceramics, intermetallic compounds, and also polymers or other composites. They may be used separately or in distinct layers to manufacture complete components, to repair worn components or to surface-coat metallic components.

Furthermore, in the example illustrated, the powder dispensing system is in the facility but distant from the head T. However, in most known 3D printers, the powder dispensing system is outside the printer.

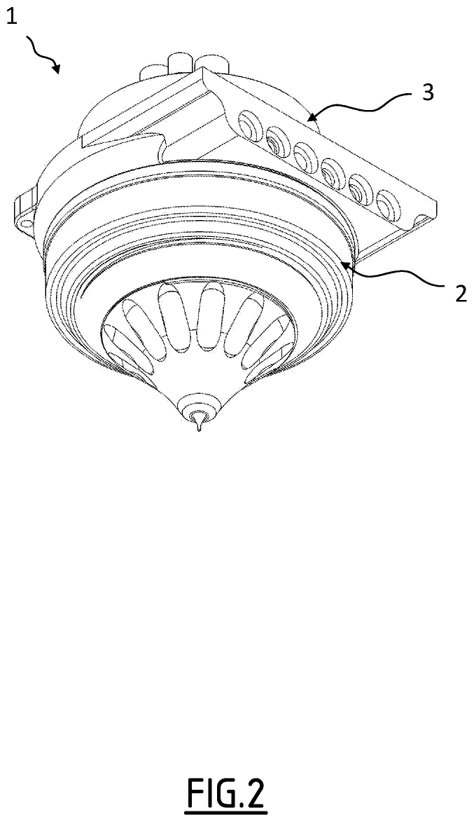

FIG. 2 shows an overall view of a powder dispensing head 1 according to a first embodiment of the invention. The head 1 comprises a body 2 of conical overall shape, and a dispensing member 3.

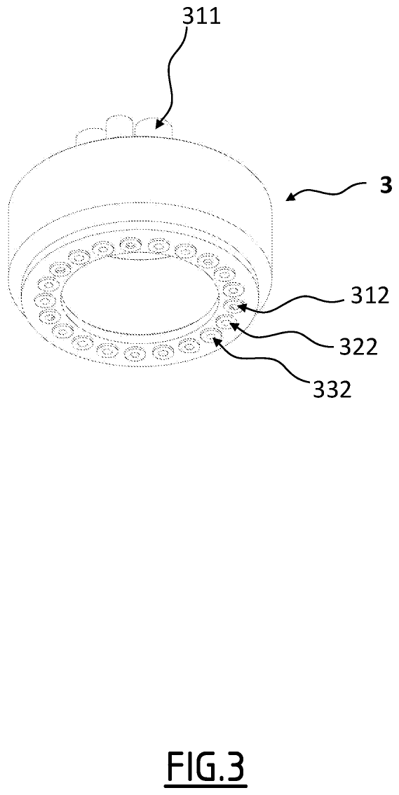

FIG. 3 shows a first exemplary embodiment of a dispensing member 3. In this exemplary embodiment, the dispensing member 3 is in the form of a ring.

In other exemplary embodiments which have not been illustrated, the dispensing member may have a shape different from that of the ring. For example, the dispensing member may have the shape of a disc or a rectangular shape.

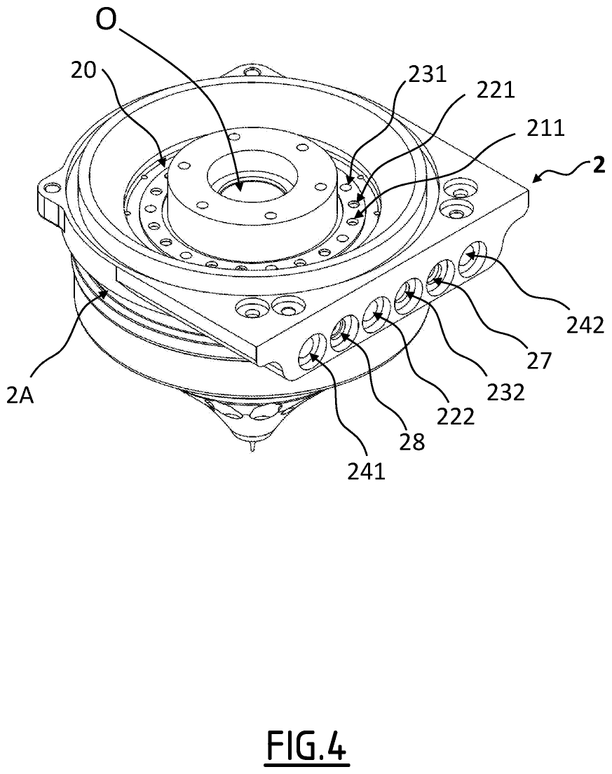

FIG. 4 depicts a partial view of a body 2. More specifically, FIG. 4 shows part of the body that will be referred to as main body 2A in the remainder of this description.

The main body 2A in the example illustrated is of cylindrical overall shape and has a bore 20 in the form of a ring intended to accept the ring of the dispensing member 3. It also has a through-opening 0 through which the laser beam L passes, as described with reference to FIG. 1.

The ring of the dispensing member 3, when the head is assembled as illustrated in FIG. 2, is in contact with the main body 2A. More specifically, the ring is inserted into the bore 20 of the main body 2A. The two components 2A and 3 are arranged in such a way that the ring can rotate with respect to the main body or, vice versa, if the ring is fixed, then it is the main body that rotates with respect to the ring.

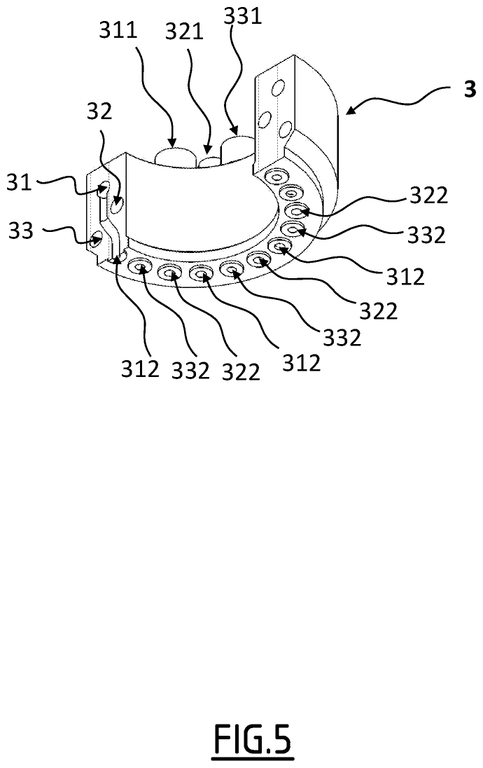

FIG. 5 shows a view in vertical section passing through the axis of rotation of the ring 3. As has been shown, the ring 3 has an annular first chamber 31 intended for dispensing a first powder PA. The first chamber 31 has a powder inlet 311 intended to be connected to a source of the first powder PA. It also has a plurality of powder outlets 312 enabling the powder PA to be dispensed.

The ring 3 also has a second chamber 32 intended for dispensing a second powder PB. The second chamber 32 has a powder inlet 321 intended to be connected to a source of the second powder PB. It also has a plurality of powder outlets 322 enabling the second powder PB to be dispensed.

The ring 3 furthermore has a third chamber 33 intended for dispensing a purge gas G, such as argon. The third chamber 33 has a gas inlet 331 intended to be connected to a source of the purge gas. It also has a plurality of gas outlets 332 enabling the purge gas G to be dispensed.

The outlets of the three chambers 31, 32, 33 are arranged uniformly so that each set of three successive outlets has to comprise a first outlet 312 of the first chamber 31, a second outlet 322 of the second chamber 32, and a third outlet 332 of the third chamber 33.

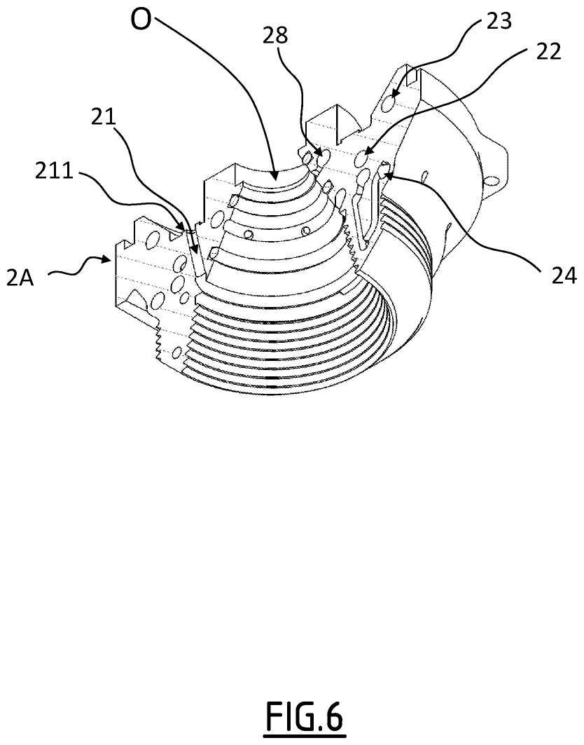

FIG. 6 shows a view in vertical cross section through the main body 2A of FIG. 4 and passing substantially through the central axis thereof.

The main body 2A has a plurality of powder conveying ducts 21 which carry the powder as far as the melting point. Each duct 21 has an inlet 221 designed to face a powder outlet 312, 322 or a gas outlet 332. One of these ducts 21 is visible in FIG. 6.

The main body 2A also comprises two powder recycling circuits 22, 23 configured to remove the powder to recycling containers RA, RB respectively.

The first recycling circuit 22 has a plurality of inlets 221 and an outlet 222 as shown in FIG. 4. The second recycling circuit 23 has a plurality of inlets 231 and an outlet 232 as shown in FIG. 4. The outlets 222 and 232 are intended to be connected to the recycling containers RA, RB respectively.

Advantageously, the number of powder conveying ducts 21, and the number of inlets 221, 231 of each recycling circuit 22, 23 is equal to the number of powder outlets 312, 322 and to the number of gas outlets 332. The inlets 211, 221, 231 of the conveying ducts 21 and of the recycling circuits 22, 23 are arranged uniformly so that each set of three successive inlets has to comprise an inlet 211 of a conveying duct, an inlet 221 of the first recycling circuit, and an inlet 231 of the second recycling circuit.

By way of example, as the dispensing ring 3 rotates with respect to the body 2, the following configurations are possible.

Configuration 1: injection of the first powder PA.

Each first outlet 312 for powder PA is fluidically connected to a powder conveying duct 21. In this case, the component is manufactured based on the first powder PA;

each second powder outlet 322 is connected to an inlet 231 of the second recycling circuit 23 to recycle the second powder PB; and

each gas outlet 332 is connected to an inlet 221 of the first recycling circuit 22 so as to purge this circuit of the residue of the first powder PA, which residue is sent to the container RA.

According to an alternative usage, when the powder PB is not needed, its supply can be cut off.

Configuration 2: injection of the second powder PB.

Each second outlet 322 for powder PB is fluidically connected to a powder conveying duct 21. In this case, the component is manufactured based on the second powder PB;

each first outlet 312 for powder PA is connected to an inlet 221 of the first recycling circuit 22 to recycle the first powder PA; and

each gas outlet 332 is connected to an inlet 231 of the second recycling circuit 23 so as to purge this circuit of the residue of the second powder PB, which residue is sent to the container RB.

According to an alternative usage, when the powder PA is not needed, its supply can be cut off, and the recycling gas can be cut off as soon as the circuit is purged.

Configuration 3: injection of powder cut off.

Each gas outlet 332 is fluidically connected to a powder conveying duct 21. In that case, the injection of powder at the melting point is cut off;

each first outlet 312 for powder PA can be connected to an inlet 221 of the first recycling circuit 22 to recycle the first powder PA; and

each second powder outlet 322 can be connected to an inlet 231 of the second recycling circuit 23 to recycle the second powder PB.

As shown in FIGS. 4 and 6, the main body 2A may also comprise a cooling circuit 24 configured to circulate a liquid coolant between a liquid inlet 241 and a liquid outlet 242. Likewise optionally, the main body may comprise a duct 27 for supplying the through-opening 0 with a stream of gas. This stream of gas serves to prevent powder from being drawn back into the through-opening 0.

The main body may also comprise a supply duct 28 supplying a stream of gas to the melting point. This stream of gas serves to adapt the size of the area covered by the powder, particularly by preventing it from being focused too narrowly into a point. This contributes to better melting of the powder by the laser beam.

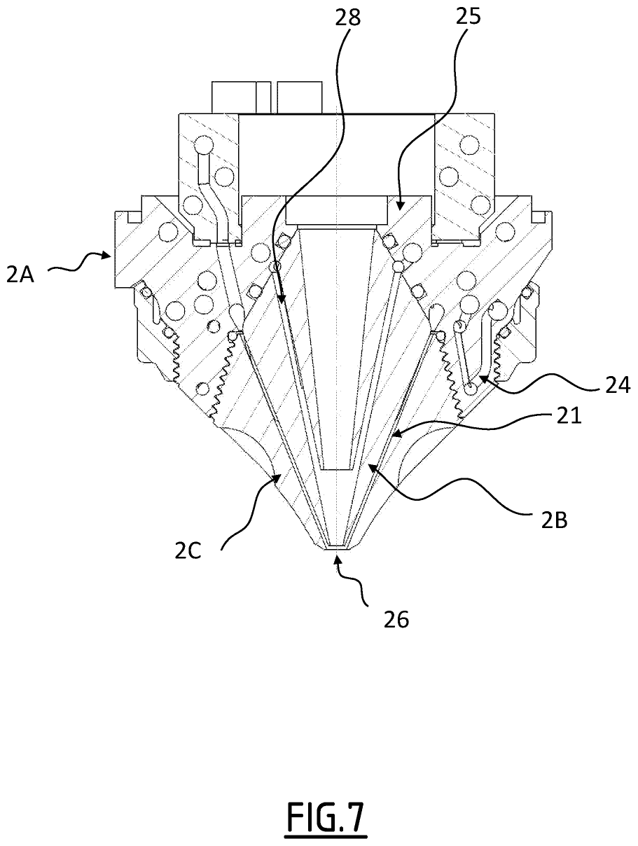

FIG. 7 shows a vertical cross section through the printing head 1 illustrated in FIGS. 2 to 6. This view shows the layout of the body 2 with the dispensing member 3 as described hereinabove.

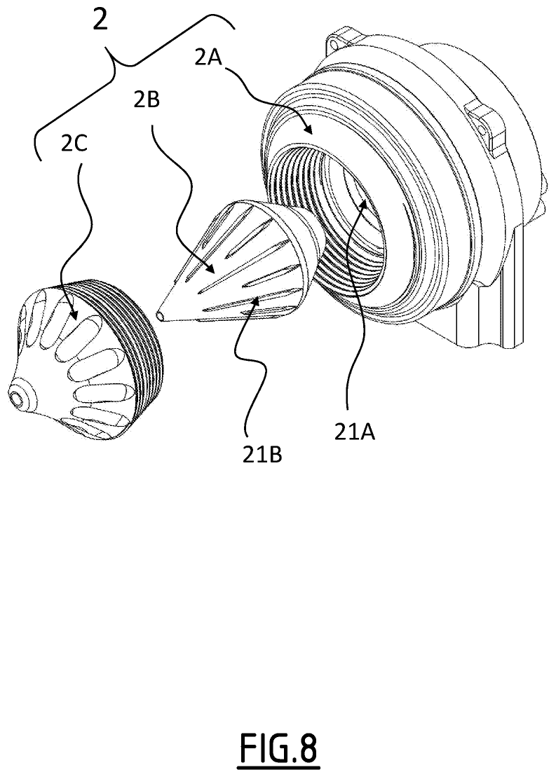

In the embodiment of FIG. 7, the body 2, as also illustrated in FIG. 8, is of conical overall shape and comprises three parts:

a main body 2A which comprises a base 25 of the cone and an upper part 21A of the powder conveying duct(s) 21;

an intermediate body 2B of conical shape, comprising a lower part 21B of the powder conveying duct(s) 21; and

an outer body 2C that fixes the intermediate body 2B to the main body 2A and that forms the vertex of the cone 26.

This advantageous configuration simplifies the maintenance of the printing head in comparison with the existing models.

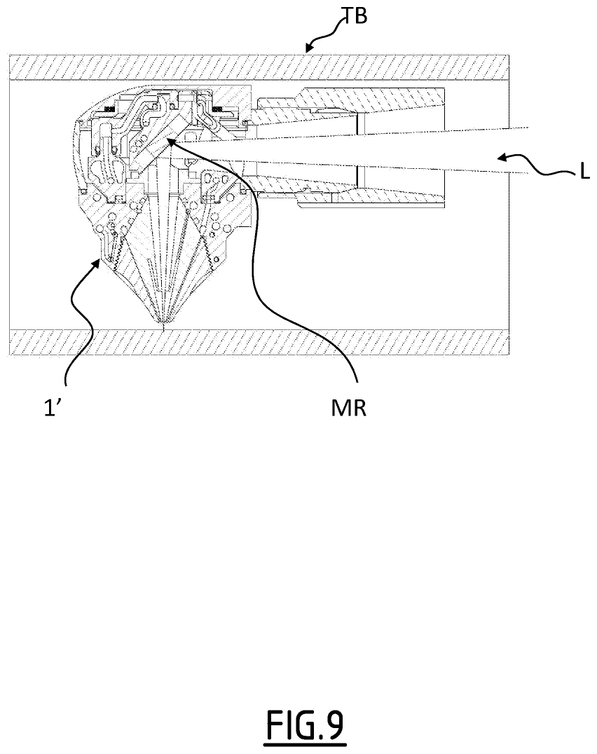

FIG. 9 illustrates a variant of the 3D printing head according to the invention. This head 1′, with a 90° elbow, is chiefly intended for the addition of material, for example in order to make a repair, inside a tube TB, particularly tubes having an inside diameter greater than or equal to 100 millimetres.

The main difference compared with the printing head 1 described hereinabove lies in its shape having a 90° elbow reducing the height of the connections and other components known from the prior art situated above the dispensing member 3. These connections are arranged mainly on one side of the dispensing member 3. This allows easy insertion inside a tube.

More specifically, the head 1′ comprises a mirror MR able to reflect the laser beam L towards the melting point.

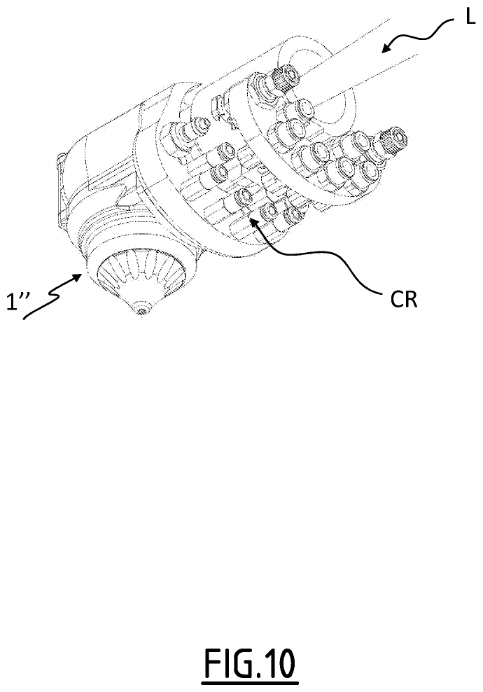

FIG. 10 illustrates a variant of the 3D printing head 1′ of FIG. 9. The head 1″ further comprises a quick-coupling system CR on the base of the head 1″. This quick-coupling system CR allows for rapid head maintenance and replacement.

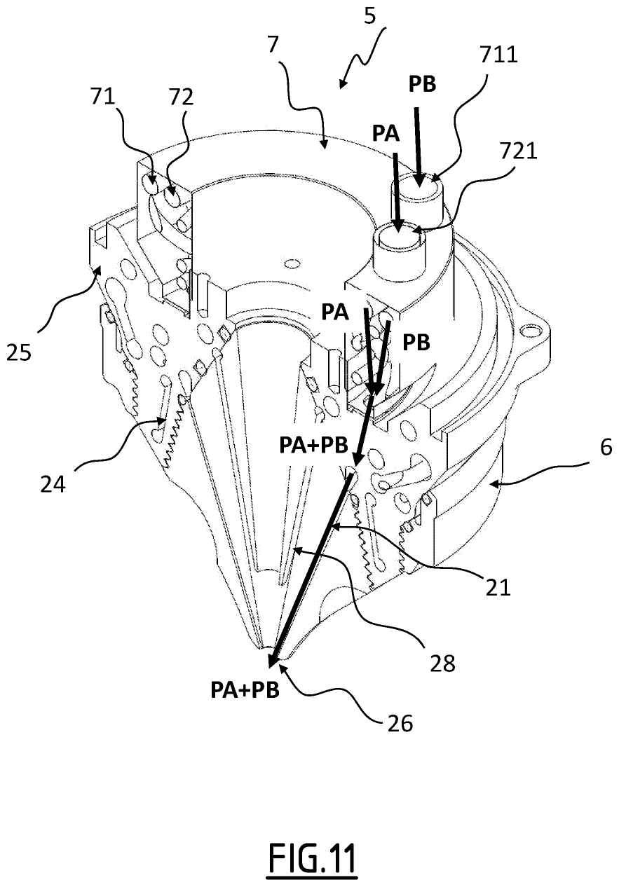

FIG. 11 illustrates a second embodiment in which the head 5 comprises a body 6 substantially similar to the body 2 of the head 1 of FIG. 2. The main difference lies in the dispensing member 7. In the example shown in FIG. 11, the dispensing ring 7 comprises two dispensing chambers 71, 72 having powder inlets 711, 721 respectively. It also comprises a mixing means configured to send into the powder conveying ducts 21 a mixture made up of a proportion of the first powder PA leaving the first chamber 71 and a proportion of the second powder PB leaving the second chamber 72.

The mixing means may, for example, comprise pairs of canals, one connected to the first chamber 71 and the other to the second chamber 72 and which converge (crossed convergence) towards an inlet 211 of a powder conveying duct 21.

The proportional metering of two powders PA, PB allows the manufacture of parts that are variable according to the concentrations of the powders PA and PB.

In that case, a device, which has not been illustrated, for metering the powders PA and PB is provided outside the head 5.

In embodiments which have not been illustrated, proportional mixtures of 3 or more powders are used.

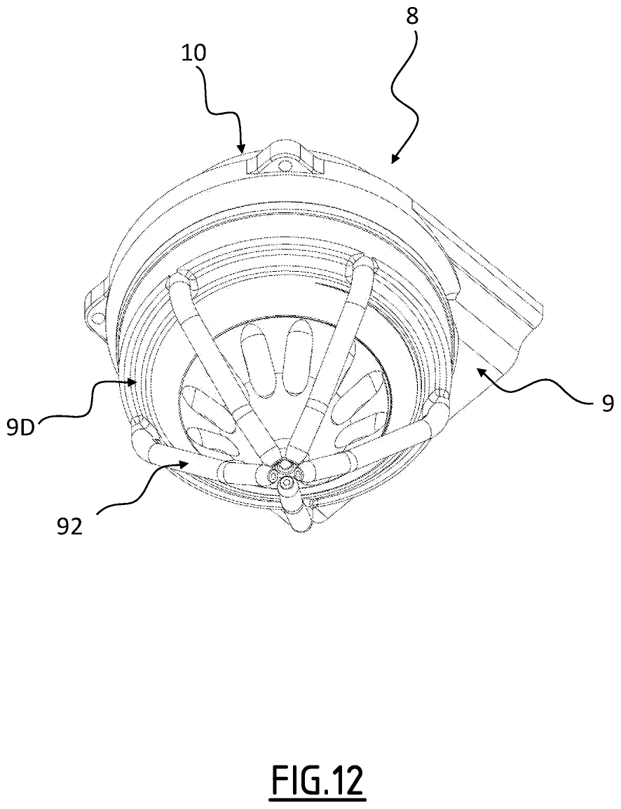

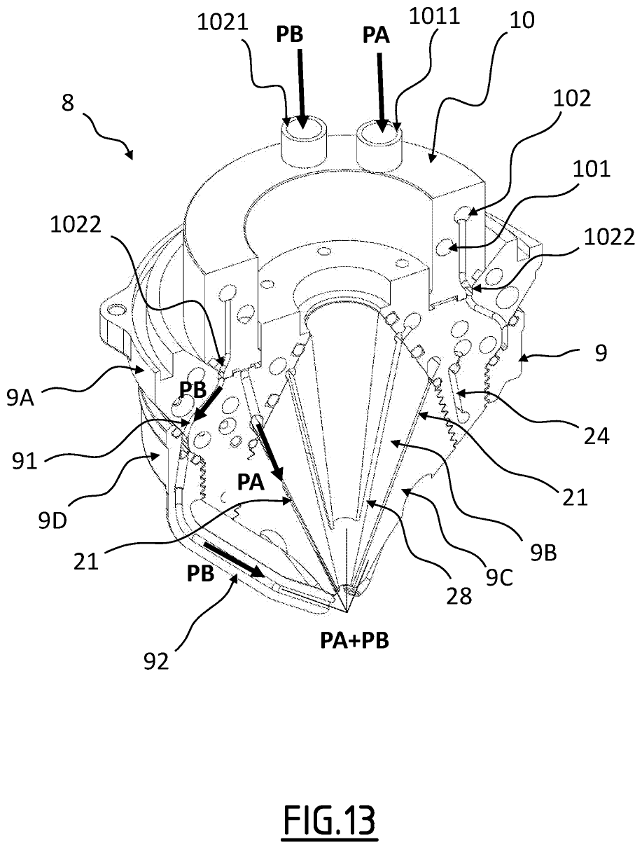

FIGS. 12 and 13 depict a variant of the head of FIG. 11 allowing the creation of a mixture of powders in which mixture one of these powders is not heated as strongly because it is passed through the exterior ducts 92.

Alternatively, only the exterior ducts 92 are supplied with powder.

The powder dispensing head 8 comprises a body 9 and a dispensing member 10.

The dispensing member 10 is substantially similar to the dispensing member 7 of the head 5 described previously. The dispensing member 10 differs in that it does not comprise a mixing means allowing a mixture of powders to be carried to the powder conveying duct 21.

The dispensing member 10 comprises a first powder dispensing chamber 101 with a powder inlet 1011 and one or more powder outlets (which are not visible in FIG. 13), each of which is intended to inject the first powder PA into a powder conveying duct 21. It also comprises a second powder dispensing chamber 102 with an inlet 1021 for powder PB and one or more powder outlets 1022.

The body 9 is similar to the body 6 described with reference to FIG. 11. It comprises a main body 9A, an intermediate body 9B and an external body 9C. The main body 9A further comprises internal ducts 91 allowing the outlets 1022 to be connected to the periphery of the main body 9A.

The body 9 further comprises an additional body 9D, for example in the form of a ring which is screwed around the main body. The additional body 9D comprises powder-conveying external ducts 92 designed to communicate fluidically with the powder outlets 1022 via the internal ducts 91. In this way, the second powder PB is conveyed to the melting point via the external ducts 92 and mixed, cold, into the molten pool.

1.-11. (canceled)

12. A powder dispensing head for an additive manufacturing machine, the powder dispensing head comprising:
a through-opening configured to allow the passage of a high-energy beam toward a melting point;
a body comprising N powder conveying ducts leading toward the melting point, the ducts being uniformly distributed about the through-opening and converging toward the melting point;
a dispensing member comprising at least one powder dispensing chamber having an inlet for powder transported by a gas; and
N powder outlets uniformly distributed about the through-opening in such a way that each powder outlet can be connected to a respective powder conveying duct,
wherein the body and the dispensing member are configured to be able to move relative to one another so as to fluidically connect or disconnect a powder outlet with respect to a powder conveying duct according to a relative position of the dispensing member with respect to the body, and
wherein N is greater than or equal to 2.

13. The powder dispensing head according to claim 12, wherein the dispensing member comprises:
a first powder dispensing chamber having a first powder inlet and N first powder outlets uniformly distributed about the through-opening; and
a second powder dispensing chamber having a second powder inlet and N second powder outlets,
wherein the body and the dispensing member have at least one position in which the first powder outlets or the second powder outlets are fluidically connected to respective powder conveying ducts.

14. The powder dispensing head according to claim 12, wherein the dispensing member comprises:
a first powder dispensing chamber having a first powder inlet and N first powder outlets uniformly distributed about the through-opening;
a second powder dispensing chamber having a second powder inlet and N second powder outlets,
wherein the dispensing member further comprises one or more powder mixing means simultaneously connecting a first powder outlet and a second powder outlet to a common powder conveying duct.

15. The powder dispensing head according to claim 13, wherein the body further comprises a powder recycling circuit configured to remove the powder to a recycling container, the dispensing member being configured to fluidically connect the first powder outlet or the second powder outlet to the recycling circuit when this outlet is disconnected from the conveying duct.

16. The powder dispensing head according to claim 15, wherein the body comprises two recycling circuits, each one configured to remove a powder to a respective recycling container, each first outlet and each second outlet being configured to be connected to a respective recycling circuit when they are disconnected from a powder conveying duct.

17. The powder dispensing head according to claim 15, wherein the dispensing member further comprises a purge gas dispensing chamber having a gas inlet and N gas outlets, the body and the dispensing member having at least one position in which the gas outlets are fluidically connected to a powder conveying duct, to the first recycling circuit, or to the second recycling circuit.

18. The powder dispensing head according to claim 13, wherein the body comprises N external powder conveying ducts configured to communicate fluidically with the powder outlets and configured to convey first powder or second powder toward the melting point.

19. The powder dispensing head according to claim 17, wherein the body comprises a number N of powder conveying ducts which are uniformly distributed about the through-opening and converge toward the melting point, the first recycling circuit and the second recycling circuit each having N inlets, each one adjacent to an inlet of a powder conveying duct, and
wherein the first and second powder dispensing chambers and the gas chamber each have N outlets distributed on the ring so that each of the N outlets faces one of the N inlets of the body, N being greater than or equal to 2.

20. The powder dispensing head according to claim 12, further comprising a cooling circuit configured to circulate a liquid coolant between a liquid inlet and a liquid outlet.

21. The powder dispensing head according to claim 20, wherein the powder dispensing head being obtained by additive manufacturing and the cooling circuit being in a form of an inbuilt network passing through various external and internal parts of the body.

22. A powder jetting additive manufacturing machine comprising the powder dispensing head according to claim 12.
